(19) United States
(12) Patent Application Publication
(10) Pub. No.: US 2025/0014886 A1
(43) Pub. Date: Jan. 9, 2025

(54) GAS-DISCHARGE LAMP, LAMP ARRAY FOR HIGH OPERATING VOLTAGES, AND USE OF SUCH LAMPS

(71) Applicant: FLAXTEC GMBH, Dresden (DE)

(72) Inventor: Harald GROSS, Langebrück (DE)

(21) Appl. No.: 18/713,356

(22) PCT Filed: May 9, 2022
(86) PCT No.: PCT/DE2022/200093

§ 371 Date: May 24, 2024

(30) Foreign Application Priority Data
Dec. 2, 2021 (DE) 10 2021 131 801.7

(51) Int. Cl. H01J 61/90; H01J 61/36

(52) U.S. Cl. CPC H01J 61/90; H01J 61/366

(57) ABSTRACT

A gas discharge lamp for use as a flash lamp comprises a closed discharge vessel; two conductors for contacting an electrode; and at least one electrical seal that encapsulates an outer portion of an electrical conductor adjacent to the wall of the closed discharge vessel. At least one electrical seal comprises an electrically insulating shielding that encloses the outer portions of the electrical conductors.

The invention relates to a gas discharge lamp of the generic type, which is configured to generate high light intensities with high electrical operating voltages, which are cooled for example with air or water. It relates in particular to a lamp array which comprises a plurality of gas discharge lamp arrangements arranged close next to one another. The invention also relates to the use of such a gas discharge lamp.

A gas discharge lamp of the generic type comprises a closed discharge vessel which is transparent for electromagnetic radiation at least in the visible range, the cavity of which is filled with a gas. It further comprises two electrodes for generating a gas discharge, each of which is arranged at one end and inside the discharge vessel. The two electrodes are contacted by two electrical conductors, which are fed through in each case a gas-tightly configured passage in the wall of the discharge vessel to the electrode.

At least that electrical conductor which is at a high electrical potential relative to ground potential is encapsulated in electrically insulating fashion in an outer portion adjacent to the wall of the discharge vessel. This encapsulation is generally referred to as an electrical seal and prevents flashover from the electrical conductor to neighboring devices or constituents of the gas discharge lamp.

High operating voltages mean voltages of several kilovolts to several tens of kilovolts, in special cases up to one hundred kilovolts. Closely neighboring lamps mean distances between nearest neighbors of the order of magnitude of the diameter of the plasma tube. High light intensities mean luminous powers of more than 1 kW/cm² to about 100 kW/cm² of the surface of the discharge vessel.

Typically, gas discharge lamps with such a light intensity have an arc length of more than half a meter up to several meters, in special cases up to ten meters. Instead of a single gas discharge lamp, it is possible to connect a plurality of lamps in series, the arc lengths of the individual lamps adding up to an overall arc length. At the two ends of the lamp series, the same voltage is then applied as in the case of a single lamp with an arc length that corresponds to the overall arc length of the lamp series, in order to achieve the same operating parameters to a first approximation.

For some applications, the gas discharge lamps are operated only briefly for less than one second, for example over a length of one millisecond or less, even in the microsecond range, as flash lamps. In order to illuminate a relatively large area, for example of one hundred square centimeters or several square meters homogenously with a high light intensity, several flash lamps with a cylindrical geometry may be arranged parallel to one another in a plane. Such lamp arrays are employed in the case of so-called “flash lamp annealing” or “photonic sintering” or coated architectural glass.

In the case of high light intensities, for example ten kilowatts per square centimeter, for a period of for example one millisecond, polymers degrade significantly, particularly when the flash lamps emit ultraviolet (UV) light. The UV component in the lamp spectrum may be almost fully absorbed by doping the glass body of the flash lamp with cerium. However, this reduces the lifetime of the flash lamp or overheating of the glass body even occurs with one exposure pulse. Some applications, for example disinfection of respiratory air or purification of effluent, are based on the action of UV light, so that doping is not possible.

In the case of the parallel arrangement of gas discharge lamps in a plane for exposure of the above-described relatively large areas, so-called leakage paths or air gaps often cannot be complied with because of small distances that are necessary in order to generate high light intensities together with homogenous illumination.

Leakage paths mean paths on surfaces of insulators on which sliding charges can move between two electrical conductors in the case of air as medium adjacent to the insulator.

Air gaps mean the distance between two electrical conductors, between which there is only air or an inert gas. In the case of deionized water, which may for example be used to cool gas discharge lamps, or else other gaseous media, there are corresponding leakage paths and liquid gaps.

As a generally known rule for DC voltages, a leakage path of at least one centimeter per kilovolt and an air gap of at least half of a centimeter per kilovolt may be applied, which is necessary in order to prevent sliding charges or ionization of air to a significant extent, or electrical flashover between the conductors. For example, an air gap of 15 centimeters between two wires with a voltage difference of 30 kilovolts should not be fallen below. The geometry of the surfaces has a significant influence on the actual values. For example, small tips on conductors increase the field strength so that the ionization of air is even possible with lower voltages. The behavior is similar in the case of electrically insulating surfaces with a water film or dirt.

For example, if a distance of one centimeter is desired between two leads of the flash lamps in order to achieve high light intensities, with an operating voltage of 20 kilovolts an additional insulator needs to be introduced between the leads since the minimum air gap required would be greater by a factor of ten. Typically, the leads are therefore sheathed with insulators such as ceramics or polymers. Ceramic materials are expensive to produce mechanically not very flexible, and have a low thermal shock resistance in comparison with polymers. For this reason, inter alia, polymers are used for the electrical leads with voltages in the kilovolt range.

Particular requirements of the electrical insulation of gas discharge lamps in the aforementioned high voltage ranges with small distances are entailed between the end of the electrical lead and the glass body of the gas discharge lamp, referred to below as the “electrical seal”. These are in particular a high operating temperature, which in many cases may be up to several hundred degrees kelvin above room temperature, a very high UV stability, good adhesion on the glass body of the lamp and the polymer of the lead, high mechanical flexibility or a coefficient of thermal expansion at least approximately equal to that of the glass body, and a sufficiently high electrical breakdown strength.

The electrical seal also needs to prevent leakage currents between the seal material itself and the glass body of the gas discharge lamp, as well as between the seal material and the polymer of the lead, i.e. needs to have a gas-tight connection to the aforementioned materials. The aging of the electrical seal due to the light of the gas discharge lamp regularly constitutes a problem, particularly when the spectrum thereof has a significant UV component. Consequently, the electrical seal loses its electrical insulation in the course of use, which may be associated with the occurrence of leakage currents that ultimately lead to the destruction of the gas discharge lamp and further component parts of the system in which the lamps are used.

This degradation process may proceed very rapidly, i.e. within a few minutes during operation. Although this process may be delayed by various measures, it cannot be prevented, or cannot be delayed for a sufficiently long time. In general, there is no polymer which has sufficiently high UV stability, since the photon energy is much greater than the bond energy in the polymer. As already mentioned, no other materials which satisfy all requirements of the electrical seal have yet been found.

Ceramic adhesives which have an expansion coefficient similar to that of quartz glass are also only limitedly suitable since they do not have a sufficient thermal shock resistance on the surface with the glass during operation of the gas discharge lamp as a flash lamp, i.e. the ceramic breaks up in the course of operation. Furthermore, it is difficult to permanently ensure a gas-tight connection to the polymer of the lead with the ceramic. A further, not unimportant aspect is that during a routine lamp change the ceramic cannot simply be cut in contrast to a shrink-on tube. Consequently, the lead needs to be replaced when a lamp is changed.

It has not yet been possible to find a suitable material which sufficiently satisfies all aforementioned requirements of an electrical seal.

On the basis of the prior art described above, the invention concerns the object of providing a gas discharge lamp with which the requirements of the electrical seal can be satisfied for the aforementioned high operating voltages.

This object is achieved by the subject matter of claim 1, the aim being to overcome the previous requirements of the electrically insulating material of the electrical seal by modifying the design of the gas discharge lamp and thus to avoid, but at least reduce, the problems of the electrical seal described in relation to the prior art, and to significantly increase the lifetime of the gas discharge lamp.

The modified design offers inter alia further advantages in respect of mounting the lamp in a housing. In particular, the modified gas discharge lamp is suitable for arrangement in a lamp array with the small distances mentioned in the introduction between the individual gas discharge lamps.

A gas discharge lamp according to the invention comprises one or more electrically insulating shieldings, which enclose those outer constituents of the gas discharge tube which are operated with a voltage of one kilovolt, preferably of more than ten kilovolts and up to one hundred kilovolts. The shielding is connected by a first end to the discharge vessel and is open at its second end lying opposite the first end.

In contrast to an electrically insulating sheathing of a conductor according to the prior art, the shielding is formed at least in portions at a distance from the encapsulated surface, i.e. at least of the electrical conductor. The distance between the inner surface of the shielding, facing toward the electrical conductor, and the electrical conductor is formed at least in each shielding a portion which is adjacent to the connection of the shielding to the discharge vessel. Optionally, the distance may be led over the length of the shielding as far as its second end. The length of the spaced-apart shielding is given in particular by the length of the constituents of the gas discharge lamp that are to be shielded.

The at least one shielding replaces the electrical seals known from the prior art and is connected to at least that one end, alternatively to both ends of the discharge vessel of the gas discharge lamp, on the electrode or electrodes of which the high operating potential is applied. The invention will be described below with reference to only one end to be electrically sealed of a gas discharge lamp. The invention may be used similarly for two electrical seals.

Currently, the discharge vessels of gas discharge lamps generally consist of glass, in particular of quartz glass because of its high transparency for electromagnetic radiation from the ultraviolet to the infrared radiation range, its low coefficient of thermal expansion and consequently its high thermal shock resistance, as well as its high electrical breakdown strength. These properties make quartz glass suitable in particular for use with the aforementioned high operating voltages, high luminous powers, and consequently the steep temperature edges that may be produced with flash lamps. The invention may, however, also be used for gas discharge lamps which use transparent and electrically insulating materials comparable with the glass, in particular the quartz glass, having the aforementioned properties. This also applies to those gas discharge lamps which might be available in the future with progressive material development, for example with ceramic glasses.

The electrical seal according to the invention produces an electrically insulating encapsulation because of the selected material. According to one configuration of the invention, the material of the shielding comprises an electrically insulating solid body as essential constituent. The material of the shielding and its connection to the discharge vessel do not, however, comprise a polymer.

A material that comprises an electrically insulating solid body as essential constituent is intended here to mean such a material composition in which the essential constituent, which determines the electrical insulation, is the electrically insulating solid body. This includes the fact that impurities related to technology or admixtures related to technology, which are useful for producing the shielding or adjusting and maintaining for example the optical properties can be contained. Such impurities or technological admixtures usually lie in the range of a few, less than 10%, of the solid body.

It is advantageous in particular that the shielding does not contain a polymer so that the problems known from the prior art can be avoided. The shielding spaced apart from the electrical conductor also makes it possible, according to a further configuration of the invention, that the electrical conductor may also be used without polymer sheathing.

For example, the shielding and the discharge vessel may consist of the same material, for example of quartz glass or another material that is suitable for both constituents. This allows an integral configuration of the two constituents of the gas discharge lamp. The equal or at least approximately equal expansion coefficient and the thermal shock resistance of the two materials connected to one another are likewise advantageous in this case. Accordingly, future material developments which relate to the discharge vessel of a gas discharge lamp may also be used for the shielding.

The shielding encapsulates at least the electrical conductor which is guided through the wall of the discharge vessel to the anode or cathode arranged in the discharge vessel.

If the electrical conductor is connected to an electrical contact electrode outside the discharge vessel, according to one configuration of the invention the contact electrode is also encapsulated by the shielding. In this case, the shielding extends beyond the region of the electrical contact electrodes in order to increase leakage paths and air gaps shielded in insulating fashion between the contact electrodes and conductive surfaces that have a different electrical potential than the contact electrodes.

That is to say, the shielding encapsulates those component parts on or from which leakage currents or collision ionizations of air gaps may occur. Such component parts may for example be contact bushings, sheathed electrical lines or electrical lines optionally not insulated over a defined portion following on from the contact bushing, or other component parts. The shielding extends the leakage paths and air gaps so that the formation of a conventional electrical seal in the region of the shielding may be obviated fully or at least in portions. For this purpose, as a function of minimum leakage paths or air gaps that are predefined inter alia by the operating voltages, the length of the shieldings may be selected freely. Preferably, the required minimum leakage paths and air gaps are complied with by the shielding, i.e. the projection of the second, open end of the shielding is equal to or greater than the minimum leakage paths and air gaps to be expected because of the operating parameters. It is optionally also possible to use electrical seals on which, however, there may be requirements less stringent than those mentioned above in relation to the prior art.

Because of the open second end of the shielding, a contact bushing may easily be fitted onto the contact electrode lying inside the shielding at the end of a connection line for the gas discharge lamp. Routine lamp changing is therefore very easy to carry out.

A further extension of the leakage paths may take place according to one configuration of the gas discharge lamp by suitable structuring of the shielding. Considered in cross section, three-dimensional geometrical structures which protrude into the space enclosed by the shielding and therefore increase the inner surface of the shielding may be formed at least on the inner surface of the shielding. For example, meandering or other surface profiles are suitable for the further extension of the leakage paths. Alternatively and with the same effect, the wall of the shielding may have such profiles.

According to various configurations, the shielding may be configured integrally with the cylindrical glass tube of the gas discharge lamp or may be connected thereto. If the connection of the shielding to the discharge vessel is configured integrally, the shielding may already be added during the production of the discharge vessel. It is in this case advantageous to make the shielding from the same material, for example quartz glass. Other configurations of the shielding are possible so long as the materials combined with one another exhibit a sufficiently compatible thermal expansion behavior. Other connections, including subsequent connections, are possible with the same proviso, so long as they are not weakened or destroyed by the light of these or neighboring gas discharge lamps.

The shielding preferably consists of a cylindrical tube, in which the contact electrodes may optionally lie on the main axis of the cylinder of the discharge vessel.

The shielding may have a constriction, particularly in order to arrange a lamp holder, a light reflector or other constituents close to the main axis of the gas discharge lamp at this location. A constriction may follow directly after a taper at the associated end of the discharge vessel of the gas discharge lamp or may form the boundary between the shielding and the discharge vessel. In such a position of the constriction, it is possible to arrange a light reflector which tightly encloses the reduced diameter of the wall and thus allows maximum protection of the component parts of the gas discharge lamp lying in the shielding from the light of the gas discharge lamp. Clearly, depending on the material used for the light reflector, it may be advantageous for the latter to have a circumferential gap from the wall of the discharge vessel and/or from the shielding.

The shielding preferably has the same or a larger or a smaller inner diameter in comparison with the inner diameter of the cylindrical glass tube of the gas discharge lamp. According to one of the aforementioned variants, good accessibility for the contact electrode inside the shielding or a reduction of the space requirement or a compact gas discharge lamp producible with reduced outlay may be made available. Further requirements of the use of the gas discharge lamp may be crucial for the configuration of the shieldings.

The shieldings may be open or closable at their second end facing away from the glass body of the gas discharge lamp. A closure may have passages for introducing a coolant into an envelope tube of the gas discharge lamp and/or for feeding an electrical line through. The closure of the shielding may also be formed by means of a lamp holder which is suitable for mounting the gas discharge lamp, for example in a housing or a complex device.

The lamp holder may thus be substantially further away from the light source, so that in the case of using polymers for the holder they are exposed to substantially less UV radiation, and/or protective devices such as the light reflector described above may be used. The light reflector may, for example, be arranged at the end of the gas discharge vessel. It may, for example, be arranged in a constriction of the shielding, which is arranged for example at the first end of the shielding.

Connection lines coming from the contact electrodes may be formed without sheathing inside the, preferably closed, shielding. In particular, an electrically insulating sheath consisting of a polymer may be obviated and the lifetime of the connection line may thus also be extended.

Forming a shielding instead of the traditional electrical seal also facilitates cooling of the gas discharge lamp with a cooling liquid, since the shielding may be configured to demarcate a volume around the connection line and preferably also around the contact electrode.

A flow tube which encapsulates the discharge vessel at a distance A and conveys the coolant in this case also surrounds the shielding, so that the electrical line contained therein and optionally also the connection line as well as the contact electrode connecting the two lines do not lie directly in the coolant and consequently also do not require electrical insulation for this region. The contact electrode may therefore also assume higher temperatures during operation since polymers do not need to be used for insulation. Only beyond the second end of the closed shielding does the electrical connection line have an insulating sheath consisting of a polymer. This achieves a distance between the use of polymers and the light source which is increased significantly in comparison with the prior art. A larger distance inter alia reduces the requirements of the materials in respect of UV stability or thermal stability.

Besides the sheathing of electrical lines, there may thus also be a connection plate consisting of at least one polymer material, which closes the shielding in gas-tight and therefore also water-tight fashion. Besides the introduction of media such as voltage and coolant or feeding signal lines through, such a connection plate may also be used simultaneously as a holder for the gas discharge lamp and for the flow tube.

Because of the described advantages of the gas discharge lamp, the latter is suitable to be used in a lamp array that comprises two or more of these gas discharge lamps, which may be arranged with a reduced distance from one another in comparison with the prior art. The internal distance L between directly neighboring lamps may be of the order of magnitude of the average outer diameter of the cylindrical discharge vessels of the lamp array or of the next smaller order of magnitude. If the average outer diameter is for example of the order of magnitude 10¹ of a particular length measurement unit, the internal distance between two neighboring discharge vessels may lie in the range of 1 (=1×10⁰) to 99 (=9.9×10¹) of the same length measurement unit. Clearly, usual tolerances for the respective embodiment and arrangement of the gas discharge lamps to be used are to be accommodated here.

According to the invention, the gas discharge lamps each have a shielding according to the description above at at least one end of the lamp. The placement in respect of parallelism and planarity of the lamp array may, for example, be adjusted with the aid of the cylinder axes or the cylindrical wall of each discharge vessel of the gas discharge lamps.

In order to determine the outer diameter of a cylindrical discharge vessel, that part of the cylinder which determines the geometry is taken into account. Locally limited narrowings, such as the above-described constriction, or similar extents are not taken into account. The average outer diameter is given by the average over all outer diameters determined in this way of the gas discharge lamps of the lamp array.

“Orders of magnitude” generally refer to the powers of ten of a value while taking its measurement unit into account. The order of magnitude of for example 10² mm consequently includes all lengths with a value of between 100 and 999 mm, it being inherent in the use of the term that “order of magnitude” that slight overshoots or undershoots of the aforementioned limit values in the range of less than or equal to 10% may be included.

The explanations relating to this gas discharge lamp may be applied correspondingly to its use in a lamp array and/or with the aforementioned potentials. The advantages of the gas discharge lamp are correspondingly associated with the use.

A further aspect of the invention therefore relates to the use of the described gas discharge lamp. Because of the configuration of the electrical seal by means of a shielding, consisting for example of glass or other suitable materials, and the avoidance or at least reduction of polymers in the immediate vicinity of the light source, high voltages in the range of one to one hundred kilovolts, for a voltage applied during illumination, and consequently high luminous powers, may be achieved. Said voltage value refers to the maximum value that the voltage can assume at the start of irradiation.

A further aspect of the invention is associated with this. The aforementioned properties and advantages of the gas discharge lamp according to the invention make it possible in particular to use a plurality of gas discharge lamps, or at least two of them, in a lamp array. Such a lamp array is suitable, for example, for treatment with high light doses for various formats of components. For example, even large-format composite components, such as photovoltaic modules or displays or components from the field of “concentrated solar power”, or architectural glass with a so-called low-E coating or the like, may be treated effectively and uniformly. Such a lamp array may also be used for other applications in the semiconductor industry or other technical fields.

For such treatments, flash lamps with which only thin interfaces of materials can be achieved with a steep temperature ramp and minimal influencing of neighboring layers are often desired. The gas discharge lamp according to the invention also facilitates such a use, both as an individual lamp and in a lamp array.

The above-described features should be explained for clarification but without restriction to the example with the aid of the associated drawings. A person skilled in the art would combine the features implemented above in the various configurations of the invention and below in the exemplary embodiment in further embodiments, insofar as they deem it expedient and practical. In the drawings,

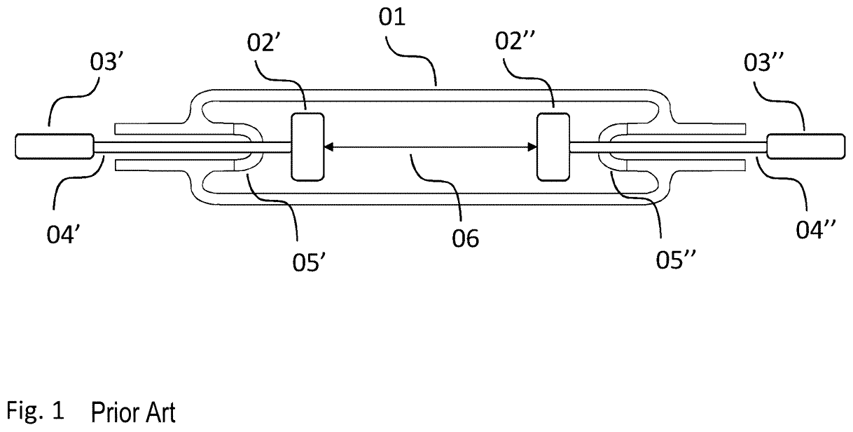

FIG. 1 shows a configuration of a gas discharge lamp according to the prior art in a sectional representation,

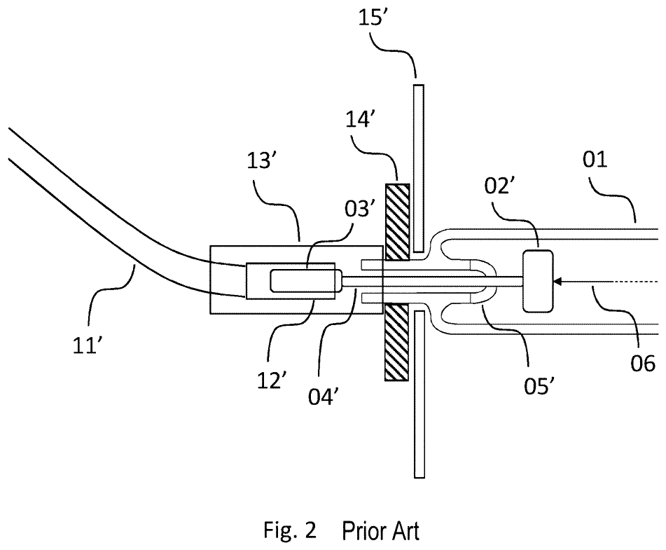

FIG. 2 shows an excerpt of a detailed representation of the left half of an air-cooled gas discharge lamp according to FIG. 1,

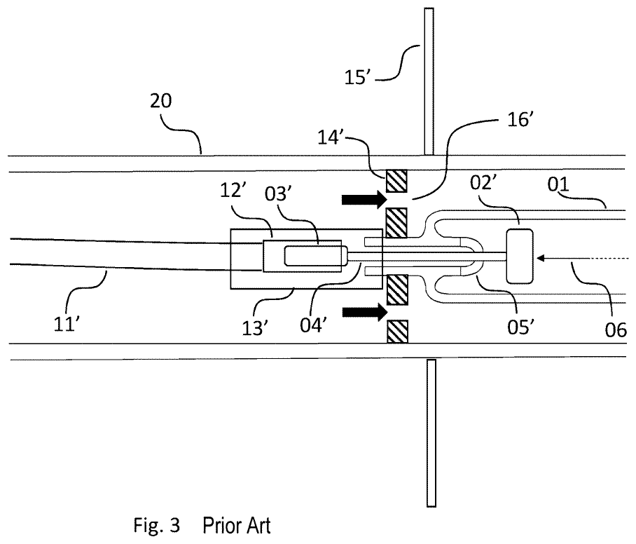

FIG. 3 shows an excerpt of a detailed representation of the left half of a water-cooled gas discharge lamp according to FIG. 1,

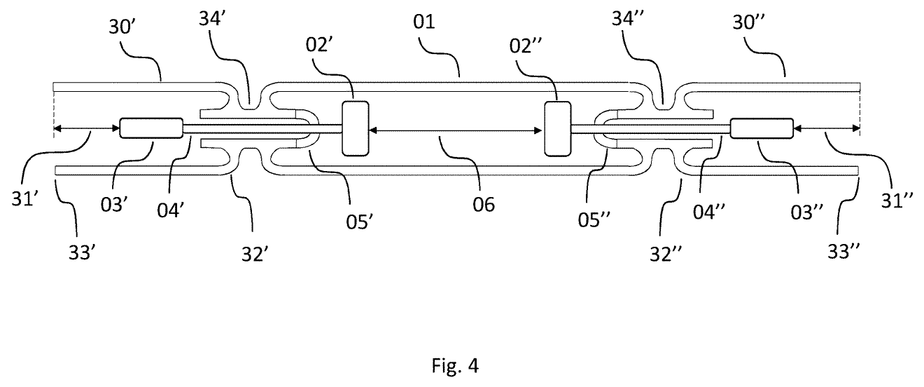

FIG. 4 shows a configuration of a gas discharge lamp according to the invention with electrical seals arranged on both sides of the lamp,

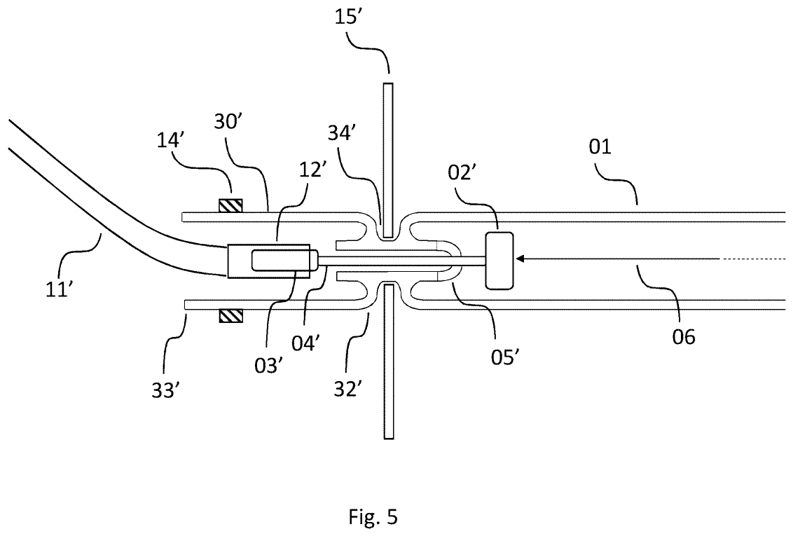

FIG. 5 shows a configuration of an air-cooled gas discharge lamp according to FIG. 4 with a light reflector, a lamp holder and a connection line in a detail representation of the left end of the lamp, and

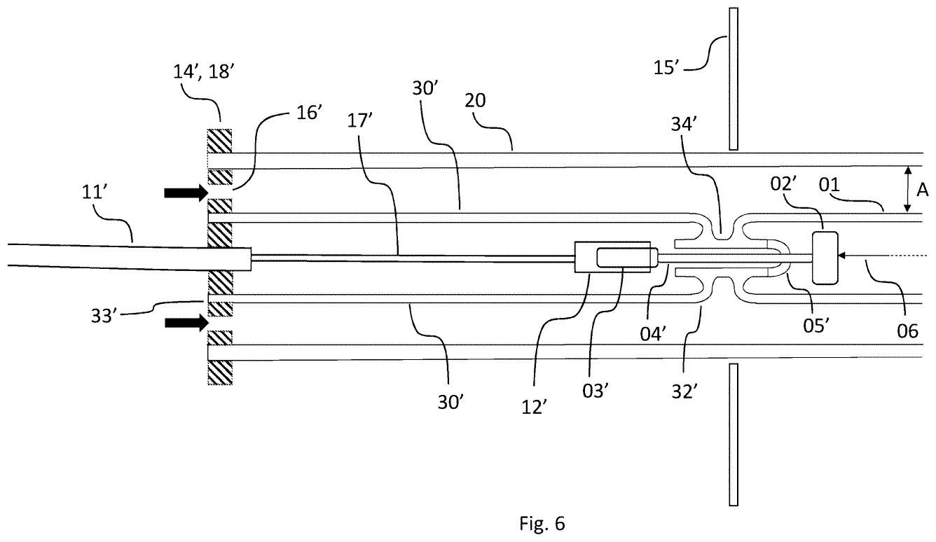

FIG. 6 shows a further configuration of a gas discharge lamp according to FIG. 4 with a light reflector, a lamp holder, a connection line and water cooling in a detail representation of the left end of the lamp.

The drawings show the device only schematically to the extent required in order to explain the invention. They do not make any claim of completeness or scale accuracy.

The drawings show the device only schematically to the extent required in order to explain the invention. They do not make any claim of completeness or scale accuracy. Component parts which are denoted by the same reference sign fulfill the same functions.

All figures which are described below show cross sections of rotationally symmetrical structural elements, the rotation axis lying horizontally in the plane of the page.

FIG. 1 shows an example of the prior art of a gas discharge lamp in cross section, consisting of a cylindrical discharge vessel 01, for example a glass body consisting of quartz glass. The cavity of the discharge vessel 01 is filled with a noble gas—for example xenon. Arranged at each end in the cavity of the discharge vessel 01 is respectively an electrode 02′, 02″, for example two tungsten electrodes, which constitute the anode and cathode of a gas discharge lamp. The arc length 06 as the actual light source of the gas discharge lamp extends between the electrodes 02′, 02″. Outside the gas-filled space, there are two contact electrodes 03′, 03″ for the electrical contacting of the gas discharge lamp on both sides, and two rod-shaped conductors 04′, 04″, which consist for example of tungsten and are used for the electrical connection of the electrodes 02′, 02″ to the contact electrodes 03′, 03″. Two transition glasses 05′, 05″, which have a coefficient of thermal expansion whose value lies between those of the discharge vessel 01 and of the material of the electrical conductors 04′, 04″, allow a current to be fed into the cavity of the discharge vessel 01. In the case outlined, the transition glass 05 is arranged in the inner region of the discharge vessel 01. In the case of gas discharge lamps with a small diameter of the glass cylinder, for example less than 16 mm in diameter, the transition glass is applied without significantly influencing the luminous power and use of the lamp, often in the outer region.

FIG. 2 shows an excerpt of a detailed representation of the left half of a gas discharge lamp according to FIG. 1, the right half having a mirror-symmetrical structure. Merely to illustrate the mirror-symmetrical representation, the reference signs represented are provided with a prime symbol . . . ′, even if the associated mirror-symmetrical component part is not to be represented in the figures.

The shape of the electrodes 02′, 02″ in the cavity, as well as the doping thereof, may be different here. For example, the cathode has heavier doping for easier ejection of electrons. In practice, there are also asymmetrical designs or designs differing from the cylindrical shape, although they do not differ inter alia from the materials used.

In addition to the representation in FIG. 1, further component parts of the gas discharge lamp are represented in FIG. 2. These are an electrical connection line 11′ sheathed with a polymer, for example silicone, an electrical contact bushing 12′, which is fitted onto the contact electrode 03′, a lamp holder 14′, for example consisting of polytetrafluoroethylene (PTFE), which is used to fasten the gas discharge lamp to a housing (not represented), and a light reflector 15′, which may have further purposes besides the function of reflecting the light of the arc length 06, for example to protect the lamp holder or other components of the housing or the electrical lead from harmful UV rays or from overheating.

The electrical seal 13′, 13″ between the polymer of the connection line 11′, 11″ and the glass body 01 of the gas discharge lamp is, for example, a shrink-on tube consisting of polyvinylidene difluoride (PVDF) with an internally lying adhesive bond for a gas-tight connection. Other gas-tight and electrically insulating electrical seals may also be used.

The arrangement of the component parts in FIG. 2 is typical of an air-cooled gas discharge lamp according to the prior art, in particular since the light reflector 15′, 15″ surrounds the glass body of the gas discharge lamp as tightly as possible but without touching it. This minimizes the exposure of structural elements, in particular the polymers used, to light, in particular UV radiation.

FIG. 3 shows a structure modified for water cooling of the gas discharge lamp. For this purpose, in most cases a flow tube 20 is used, consisting for example of quartz glass, through which highly pure deionized water is pumped. The centering of the gas discharge lamp in the flow tube 20 is carried out by a lamp holder 14′, 14″, which consists for example of polytetrafluoroethylene (PTFE) and has suitable passages 16′, 16″, for example boreholes for the cooling water flow (represented by arrows, the direction of which is represented merely by way of example but without restriction). In the exemplary embodiment, the light reflector 15′, 15″ is located outside the flow tube 20.

The gas discharge lamp according to FIG. 1 to FIG. 3 represents an exemplary embodiment according to the prior art. Various constituents with the same functionality may be configured differently, for example in terms of geometry, in terms of material, in terms of spatial arrangement or in terms interaction with further constituents, or other details.

In all figures shown so far, which illustrate the prior art, despite shading by the light reflector 15′, 15″ or the lamp holder 14′, 14″, a significant fraction of the light generated by the gas discharge lamp impinges on the electrical seal 12′, 12″, specifically at least on the area over which the electrical seal 12′, 12″ has contact with the discharge vessel 01 of the gas discharge lamp. One consequence is the aforementioned breakup of the adhesive bond of the electrical seal 12′, 12″ and the formation and progressive increase of leakage currents, which ultimately lead to electrical flashover or to the destruction of the gas discharge lamp. The transition glasses 05′, 05″, as explained in the introduction to the prior art, also increase the lifetime of the gas discharge lamps only in some applications.

FIG. 4 shows a gas discharge lamp according to the invention with the constituents of the generic type inside the cylindrical discharge vessel 01. These are two electrodes 02′, 02″ of consisting tungsten for generating and maintaining the arc length 06, its electrical connections by means of electrical conductors 04′, 04″ and the feed of the electrical conductors 04′, 04″ through the wall of the discharge vessel 01 by means of transition glasses 05′, 05″. The transition of the discharge vessel 01 to the shielding 30′, 30″ consisting of glass is formed in the exemplary embodiment on both sides by a constriction 34′, 34″. The material of the shielding 30′, 30″ may correspond to that of the discharge vessel 01 or differ therefrom at least in individual constituents, SO long as the material properties described above can be ensured.

The gas discharge lamp respectively comprises, at both ends of the discharge vessel 01, an electrically insulating shielding 30′, 30″ that encapsulates the contact electrode 03′, 03″ there. The shielding 30′, 30″ is integrally connected to the discharge vessel 01 at its first end 32″, 32″ and is open at the opposite second end 33′, 33″. There, it protrudes beyond the contact electrode 03′, 03″.

Due to the arrangement and length of the shielding 30′, 30″ , both the contact electrode 03′, 03″ and a portion of the electrical leads 04′, 04″ to be connected thereto of the electrodes 03′, 03″ are encapsulated by the shielding 30′, 30″. In addition, a portion of the connection line 11′, 11″ of the gas discharge lamp may also be encapsulated.

The shielding 30′, 30″ in FIG. 4 is configured by way of example, but without restriction, as a cylindrical glass tube extension and may already be added during the production of the gas discharge lamp. In addition, the second end 33′, 33″ of the shielding 30′, 30″, which is represented as being open may be closable.

The diameter of the shielding 30′, 30″ represented in FIG. 4 corresponds to the cylinder of the discharge vessel 01, specifically in the portion between the tungsten electrodes 02′, 02″ which imparts the shape. In principle, however, any diameter is possible as a function of the specific requirements, without changing the operating parameters of the gas discharge lamp. Likewise the length of the shielding 30′, 30″ with or without surface structuring, or the internal projection 31′, 31″ of the second end 33′, 33″ of the shielding 30′, 30″ beyond the end of the contact electrode 32′, 32″, as described above, may be selected freely.

In a similar way to the configuration known from the prior art with a light reflector and a lamp holder, the embodiment according to FIG. 5 has these constituents. FIG. 5 represents a configuration of the gas discharge lamp according to FIG. 4 with a light reflector 15′, 15″ and a lamp holder 14′, 14″.

For optimal protection of the component parts located outside the discharge vessel 01 from the light of the arc length 06, the plate-shaped light reflector 15′, 15″ is arranged in a constriction 34′, 34″ between the integrally configured glass tube of the discharge vessel 01 and the shielding 30′, 30″ and extends radially.

The likewise plate-shaped lamp holder 14′, 14″ may be mounted at the second end 33′, 33″ of the shielding 30′, 30″, where it is protected by the light reflector 15′, 15″ from harmful radiation of the gas discharge lamp. It is used to hold the gas discharge lamp in a housing (not represented). It may in this case establish a distance from the housing wall, which may be used for air cooling of the gas discharge lamp.

In a further exemplary embodiment of a gas discharge lamp according to FIG. 4, the gas discharge lamp is water-cooled (FIG. 6). For this purpose, the gas discharge lamp is arranged in a flow tube 20. A lamp holder 14′, 14″ arranged on both sides of the gas discharge vessel 01 respectively closes the flow tube 20 and holds it at a distance from the discharge vessel 01, and therefore also from the shieldings 30′, 30″ configured by way of example as a glass tube extension.

Like the flow tube 20, the latter end at the lamp holder 14′, 14″ so that the lamp holder 14′, 14″ also closes the shielding 30′, 30″.

The lamp holder 14′, 14″ has a suitable passage 16′, 16″ for feeding the electrical connection line 11′, 11″ of the gas discharge lamp through into the shielding 30′, 30″ and to the contact electrodes 03′, 03″. Further passages 16′, 16″ lying outside the shielding 30′, 30″ are used to feed and discharge a suitable coolant (represented by arrows), for example water or air or another suitable fluid.

Because of the closure of the shielding 30′, 30″ by the connection plate 14′, 14″, the contact electrode 03′, 03″ and the lines 04′, 04″, 11′, 11″ connected thereto have no contact with the coolant, so that these lines 04′, 04″, 11′, 11″ may be used without insulating sheathing, in particular without such a sheathing consisting of a polymer. This unsheathed or differently sheathed portion of the connection lines is denoted by the reference sign 17′, 17″ in order to distinguish it.

One light reflector 15′, 15″ per side of the discharge vessel 01 is optionally arranged outside the flow tube 20 in the region of the constriction 34′, 34″.

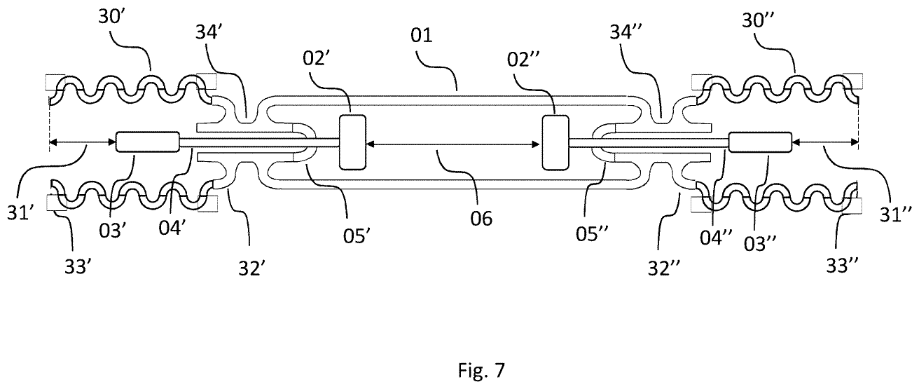

FIG. 7 shows a gas discharge lamp based on that of FIG. 4. The two lamps differ by the embodiment of the wall of the shielding 30′, 30″. It is configured meandering from the second end 33′, 33″ to near the first end 32′, 32″, so as to increase the surface of the shielding 30′, 30″, in particular the inner surface.

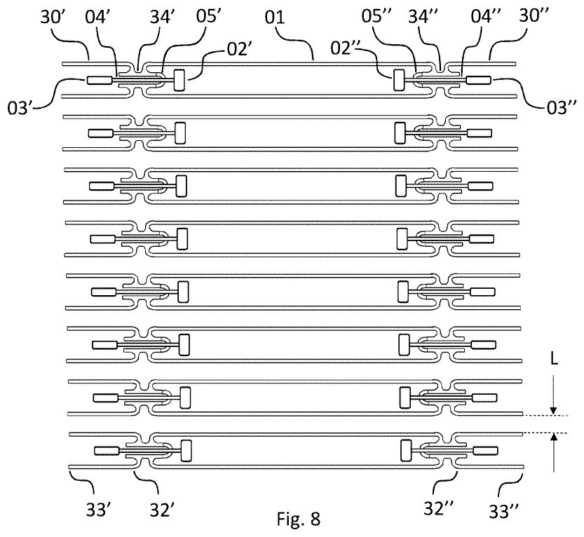

FIG. 8 represents a lamp array in which a plurality of gas discharge lamps according to FIG. 4 are arranged in a plane, in the present representation of the plane of the drawing, next to one another and parallel to one another. Their internal distance L from one another, measured between the walls of the discharge vessel 01, is of the next smaller order of magnitude of the uniform outer diameter of the cylindrical discharge vessels of the lamp array. For the configuration of the gas discharge lamps of the lamp array, reference is made to the description relating to FIG. 4.

### LIST OF REFERENCES

01 discharge vessel
02′, 02″ electrode
03′, 03″ contact electrode
04′, 04″ conductor
05′, 05″ transition glass
06 arc length
11′, 11″ connection line
12′, 12″ contact bushing
13′, 13″ electrical seal
14′, 14″ lamp holder
15′, 15″ light reflector
16′, 16″ passage
17′, 17″ connection line
18′, 18″ connection plate
20 flow tube
30′, 30″ shielding
31′, 31″ internal projection
32′, 32″ first end
33′, 33″ second end
34′, 34″ constriction
A distance between the gas discharge vessel and the flow tube
L internal distance between two gas discharge lamps

1-15. (canceled)

16. A flash lamp, comprising:
a discharge vessel that is transparent to electromagnetic radiation in the visible spectrum and defining a cavity filled with a gas, wherein the discharge vessel defines passages at opposing ends of the cavity;
two electrodes for generating a gas discharge and positioned at the opposing ends of the cavity of the discharge vessel;
two electrical conductors respectively connected to the two electrodes and respectively extending through the passages at the opposing ends of the cavity of the discharge vessel; and
at least one insulating shielding spaced-away from and enclosing at least one of the two electrical conductors outside of the discharge vessel, wherein the at least one insulating shielding comprises a first end that is connected in a gas-tight fashion to the discharge vessel and a second end opposite the first end that is open.

17. The flash lamp of claim 16, wherein the at least one insulating shielding comprises an electrically insulating solid body that does not comprise a polymer.

18. The flash lamp of claim 16, further comprising:
two contact electrodes respectively connected to the two electrical conductors, wherein the at least one insulating shielding extends from the discharge vessel beyond at least one of the two contact electrodes.

19. The flash lamp of claim 18, further comprising:
two electrical connection lines respectively connected to the two contact electrodes, and wherein the two electrical connection lines do not have electrically insulating sheaths that comprise a polymer.

20. The flash lamp of claim 18, wherein the at least one insulating shielding has an inner surface with geometrical structures that protrude toward a respective contact electrode of the two contact electrodes.

21. The flash lamp of claim 20, wherein the inner surface undulates from the first end to the second end.

22. The flash lamp of claim 16, wherein the at least one insulating shielding is coaxial with the discharge vessel.

23. The flash lamp of claim 16, wherein the at least one insulating shielding is integral with the discharge vessel.

24. The flash lamp of claim 16, wherein the at least one insulating shielding and the discharge vessel are constructed of the same material.

25. The flash lamp of claim 16, wherein the at least one insulating shielding comprises a constriction at the first end or between the first end and the second end.

26. The flash lamp of claim 16, wherein the second end is configured to be closed with feed-throughs for electrical connection lines.

27. The flash lamp of claim 16, further comprising:
a light holder or a light reflector on the at least one insulating shielding.

28. The flash lamp of claim 16, further comprising:
a flow tube that encapsulates the discharge vessel a radial distance away from the discharge vessel for a flow medium around the discharge vessel.

29. The flash lamp of claim 28, further comprising two connection plates that respectively close ends of the flow tube, wherein each connection plate of the two connection plates comprises passages for the flow medium and for an electrical connection line.

30. The flash lamp of claim 29, wherein each connection plate of the two connection plates holds the second end of the at least one insulating shielding.

31. A lamp array, comprising:
gas discharge lamps arranged in a plane parallel to one another and spaced-apart by a distance, wherein at least one of the gas discharge lamps if the flash lamp of claim 16, and wherein the distance is of an order of magnitude of an average outer diameter of the discharge vessels of the gas discharge lamps or of the next smaller order of magnitude.

32. A method of using the lamp array of claim 31, comprising:
irradiating a photovoltaic module, a display, a coated architectural glass, or a component part in the field of concentrated solar power.

33. A method of using the flash lamp of claim 16, comprising:
irradiating substrates with a voltage applied during a treatment, a maximum value of which is in the range of 1 kV (kilovolt) to 100 kV and/or with a luminous power emitted during a treatment of 1 kilowatt per square centimeter (kW/cm²) to 100 kW/cm².
